(19) United States
(12) Patent Application Publication
(10) Pub. No.: US 2014/0095719 A1
(43) Pub. Date: Apr. 3, 2014

(54) CREATING, REGISTERING, AND TRADING UNITS REPRESENTING INTERNET PROTOCOL NUMBERS

(71) Applicant: Harris Andrew Decker, Briarcliff Manor, NY (US)

(72) Inventor: Harris Andrew Decker, Briarcliff Manor, NY (US)

(21) Appl. No.: 13/698,946

(22) PCT Filed: Oct. 3, 2012
(86) PCT No.: PCT/US12/58570

§ 371 Date: Nov. 19, 2012

(51) Int. Cl. H04L 29/12

(52) U.S. Cl. CPC H04L 61/2007
USPC 709/226

(57) ABSTRACT

The instant application describes a central registry computer system comprising a) a network interface configured for communication via a network; b) a processing unit configured to receive a plurality of transactions over the network via the interface, each transaction containing a request either (1) for registering an IP Unit representing a IP Number or (2) for transacting the IP Unit, wherein the IP Number enables relay of network packets between devices connected on an IP network; c) a storage device accessible by the processing unit; and d) executable instructions stored in the storage device for the processing unit. The instructions configure the system to: receive over the network a registration request from a first party device to register the IP Unit representing the IP Number in a central database of IP Units and register in the central database of IP Units the IP Unit against a unique central registry ID associated with the first party device.

### TECHNICAL FIELD

The present subject matter relates to techniques and systems for creating, registering, and trading units representing Internet Protocol numbers.

### BACKGROUND

The Internet Protocol (“IP”) defines the system and addressing schemes for the relaying of datagrams or network packets between and among devices (real or virtual) connected by a network that utilizes IP (an “IP Network”). IP is the foundation of the Internet, which represents a global inter-connected network of IP networks. A device (real or virtual) on an IP Network requires an address (an “IP Address”) that is unique within the boundaries of that IP Network or those interconnected IP Networks to which that IP Address is exposed. An IP Address is a binary number that conforms to IP standards and can be interpreted by devices on an IP Network (an “IP Number”) as an IP Address.

There are currently two versions of IP bioadly deployed and utilized by devices on IP Networks Version 4 (“IPv4”) initially deployed in 1983 and Version 6 (“IPv6”) initially deployed beginning in 1999. IPv4 relies upon a 32-bit binary number (generally represented in dot-decimal notation consisting of four decimal numbers, each ranging from 0 to 255, separated by dots in the text format 172.16.254.1 but also sometimes represented in hexadecimal, octal, or binary formats). By definition, a 32-bit binary number yields a maximum of approximately 4.3 billion (2³²) unique IP Numbers that can be used on an IP Network based on IPv4 (of which approximately 587 million IP Numbers are reserved for special purposes or future use in IPv4). Among other changes to IP. IPv6 relies upon a 128 bit binary number to define the address space—versus 32 bits in IPv4—or 16 octets (generally represented in the format 2001:db8:0:1234:0:567:8:1) which creates an addressable space of 2¹²⁸ (approximately 3.4*10³⁸) IP Numbers (some of which are also reserved in IPv6). While the IPv6 address space is vastly larger than the IPv4 address space (approximately 9.7*10²⁸ times larger), other changes to IP were also implemented in IPv6 to facilitate more efficient management of IP Networks.

Many modern IP devices and systems—real and virtual—now include native support for the IPv6; however, IPv6 is not yet widely deployed in other devices, such as home networking routers, voice over IP, multimedia equipment, and network peripherals. Accordingly. IPv4 and IP Numbers that comply with IPv4 will remain relevant and necessary for many years as devices—real or virtual—that rely upon IPv4 are added to IP Networks until such IP Networks that utilize IPv4 (and all of the devices on such networks that rely upon IPv4) are upgraded, replaced or decommissioned.

The earliest work on the networking technologies and techniques that would support the development of the Internet was undertaken in connection with work on the U.S. Defense Department's Defense Advanced Research Projects Agency's (“DARPA”) network (the “ARPANET”) launched in 1969 and the National Science Foundation Network (“NSFNET”) launched in the mid-1980's. As these early packet switching networks evolved, the need for listing, managing, and allocating IP Numbers to be used as IP Addresses became more important. Initially this was managed by individuals employed by the RAND Corporation and the University of California at Los Angeles (“UCLA”) and subsequently the University of Southern California (“USC”) and its Information Sciences Institute (“ISI”). Beginning in early 1988, these efforts were funded in part by grants from DARPA to ISI.

Beginning in the early 1990s, these ad hoc efforts were organized by ISI under the Internet Assigned Numbers Authority (“IANA”), which was described in RFC 1700 in October 1994 as having been chartered by the “Internet Society [an international, non-profit organization founded in 1992 to provide leadership in Internet related standards, education, and policy] and the Federal Network Council [originally chartered by the National Science and Technology Council (which had been established by Executive Order 12881) to act as a forum for networking collaborations among Federal agencies to meet their research, education, and operational mission goals and to bridge the gap between the advanced networking technologies being developed by federal research agencies and the commercial sector] to act as the clearinghouse to assign and coordinate the use of numerous Internet protocol parameters.” As further described in RFC 1700, “it is the task of the IANA to make those unique assignments as requested and to maintain a registry of the currently assigned values.”

In early 1998, the National Telecommunications and Information Administration, an agency of the U.S. Department of Commerce (“DoC”), began a process that lead to the creation of the Internet Corporation for Assigned Names and Numbers (“ICANN”) in September 1998. ICANN was organized as a nonprofit private organization to oversee a number of Internet-related management tasks previously performed directly on behalf of the U.S. government by other organizations including IANA. In November 1998, the DoC and ICANN entered into a “Memorandum of Understanding” pursuant to which ICANN agreed among other things to “[p]rovide expertise and advice on private sector functions related to technical management of the DNS [domain name system] such as the policy and direction of the allocation of IP Number blocks and coordination of the assignment of other Internet technical parameters as needed to maintain universal connectivity on the Internet.” In December 1998, USC entered into a formal transition agreement with ICANN transferring IANA and its functions to ICANN effective Jan. 1, 1999. On Feb. 8, 2000, the DoC entered into an agreement with ICANN to fund its operations including the functions performed by IANA.

ICANN has delegated various administrative responsibilities for the allocation of IP Numbers (IPv4 and IPv6) and the Autonomous System Numbers within their respective geographical regions to Regional Internet Registries (each a “RIR” and collectively the “RIRs”). In turn, it is the RIRs that divide their allocated pools of IP Numbers into smaller blocks and assign them within their respective operating regions to Internet service providers and other organizations.

The three original RIRs recognized by ICANN included the American Registry For Internet Numbers, Ltd., a Virginia non-profit corporation incorporated in August 1997 that opened for operation in December 1997 originally serving North and South America. the Caribbean, and sub-Saharan Africa (“ARIN”); Asia Pacific Network Information Centre, an Australian non-profit company incorporated in February 1999 but that traces its roots to 1992 that serves the Asia Pacific region (“APNIC”), and Réseaux Internet Protocol Européens Network Coordination Centre, a non-profit membership association organized in November 1997 but that traces its roots to 1989 (“RIPE NCC”). Subsequently, in October 2002, ICANN recognized the Latin American and Caribbean Internet Addresses Registry (“LACNIC”) and in April 2005, AFRINIC Ltd. (“AfriNIC”) as the fourth and fifth of the RIRs.

IP Numbers and in particular, IP Numbers that conform to IPv4, have been in use since the early 1980s (see RFC 791 published in September 1981) with ICANN having recognized the assignment of IP Numbers as having been made as early as 1981. Indeed, ICANN has recognized that approximately 1.9 billion IP Numbers had been assigned prior to ICANN's formation. In April 2002, ICANN and the original three RIRs acknowledged that the numbering resources are to be managed for the use and benefit of present and future operators and users of the Internet. Since certain numbering resources and their usage are limited by IP technology, these parties (and their predecessors) have since 1991 co-operated to coordinate the provision of numbering resources to operators and users of the Internet in support of present Internet operations and the future development of the Internet. The stated objectives of these parties has been to achieve a level of coordination in an open and transparent manner involving as little cost as possible for the operators and users.

ICANN's inventory of unallocated IPv4 Numbers has now been exhausted with its IPv4 IP Numbers having been assigned or allocated to organizations and the RIRs (including assignments of IP Numbers made prior to the formation of ICANN and the RIRs). Substantially all of the unassigned IP Numbers allocated to the RIRs by ICANN also have now been assigned by the RIRs to network operators and other governmental, academic and private sector parties that have in general agreed to be bound by certain rules and regulations of the RIRs as reflected in a so called Registration Services Agreement (“RSA”). Network operators and other organizations that need additional IPv4 IP Numbers are now forced to seek to acquire IPv4 IP Numbers from existing holders.

Some of the RIRs (RIPE NCC, ARIN and APNIC) now offer processes by which IP Numbers that have been assigned may be transferred if the transferor and transferee either are already or agree to be thereafter subject to the RIR's governance provisions included in an RSA. These provisions include the RIR's right to make determinations as to the necessity of the parties' requirements for IP Numbers. However, there is no comprehensive global process that governs the rights of holders of IPv4 IP Numbers including the circumstances under which a holder may have a right to transfer IP Numbers that have been allocated or assigned to them (particularly those assigned prior to the formation of ICANN (“Legacy IP Numbers”), which constitute approximately 52% of the maximum possible usable IPv4 IP Numbers).

While the RIRs' processes offers one approach to facilitate the transfer of IP Numbers between parties that choose to become subject to the RIR's rules and regulations (including the RIRs' self-proclaimed right to unilaterally review and deny the proposed transfer of IP Numbers by a party that has accepted its rules and regulations), such processes do not apply to holders of Legacy IP Numbers that do not subject themselves to the RIR's jurisdiction or may only apply in part based upon negotiated arrangements between the holder of Legacy IP Numbers and a RIR (as reflected in a so called Legacy Registration Services Agreement (“Legacy RSA”)).

In any case, RIR processes are not based upon a statutory authority and may be enforceable only as matter of contract against a party that has entered into a RSA or a Legacy RSA with an RIR. In general, RIR's determinations are not subject to customary regulatory safeguards of review and appeal (except to the limited extent of judicial redress in connection with contractual matters in the case of a party and a RIR that have executed a RSA or a Legacy RSA).

Indeed, there is no specific legal authority underpinning the organization or operation of the Internet as a whole or that creates a global framework specifying the rights and responsibilities of a person or organization to which IP Numbers had been allocated or assigned (including for that matter, ICANN and the RIRs). Since roughly 2002, parties seeking the assignment of unassigned IP Numbers have been required to submit to the suzerainty of ICANN and the RIRs. However, ICANN and IANA (through its oversight of the Internet's root zone of the Domain Name System (“DNS”) and registry of Autonomous System Numbers) are not even required to recognize prior allocations or transfers of IP Numbers among assignees including in theory, even transfers that have been executed under the jurisdiction of an RIR.

In other words, a series of informal arrangements evolved over time to address the needs of organizations and users of IP Numbers (mostly IPv4 until recently) in an environment in which a supply of unallocated and unassigned IPv4 Numbers was available to be parceled out to satisfy the unmet needs of users. However, now that the supply of unallocated and unassigned IPv4 Numbers has been essentially exhausted, the absence of a recognized global system to accommodate the orderly redistribution of IP Numbers presents a significant constraint and poses a risk to users of IP Networks—particularly those relying upon IPv4.

The informal mechanisms that have evolved since the early 1980s are simply not sufficiently robust to allow those possessing or seeking IP Numbers to identify one another and reconcile their respective holdings to produce an optimal distribution. This has inhibited the development of a market-based mechanism that would accommodate the orderly redistribution of the now increasingly scarce supply of IPv4 IP Numbers. This also has inhibited the development of mechanisms to accommodate the transfer of IP Numbers and has further limited the capacities of both holders and those seeking to acquire IP Numbers to specify legal recourse in respect of IP Numbers limiting the ability of holders of IP Numbers to recognize them in the normal course of their financing (and accounting) operations. This lack of legal or widely accepted foundation for a global system governing the rights of holders of IP Numbers increases the risk that costly legal and economic conflicts will arise as users seek to meet their requirements for IP Numbers and holders of IP Numbers seek to protect their rights with respect to the IP Numbers they possess.

Hence a need exists for a system and method to enable parties to efficiently and effectively transfer the rights to utilize and exploit IP Numbers. Specifically, a need exists for a system and method to enables parties to create, centrally register, and trade units representing IP Numbers.

### SUMMARY

In one general aspect, the instant application describes a central registry electronic system that includes a) a network interface configured for communication via a network; b) a processing unit configured to receive transactions over the network via the interface, each transaction containing a request to (1) register an Internet Protocol (IP) Unit representing an IP Number or (2) transact in an IP Unit; c) a storage device accessible by the processing unit; and d) executable instructions stored in the storage device for the processing unit. The instructions configures the system to: receive over the network a registration request from a first party device to register the IP Unit in a central database of IP Units; upon receiving the registration request, identify a unique central registry ID associated with the first party device; register in the central database of IP Units the IP Unit against the unique central registry ID associated with the first party device; receive over the network and from a second party device a transaction request for transacting IP Units; determine whether the second party device is qualified to transact IP Units; upon determining the second party device is qualified to transact IP Units, enable the second party device access to a trading database recording availability of IP Units and open interest of potential sellers or buyers of one or more IP Units; responsive to enable access to the trading database, receive over the network a transaction notification of IP Unit transaction between the first party device the second party device; responsive to the transaction notification, automatically generate a transfer notification to reflect transfer of IP Units between an account associated with the first party device and an account associated with the second party device; and forward the transfer notification to a transfer notification database to enable the transfer notification database to update the central database of IP Units to reflect the transfer of IP Units between the account associated with the first party device and the account associated with the second party device.

The above general aspect may include one or more of the following features. An IP Unit may be an instrument that represents the indefeasible right to utilize an IP Number to which the instrument corresponds. An IP Unit may be a share of capital stock or similar interest in an entity or other security convertible or exchangeable into a share of capital stock or similar interest in an entity; a debt obligation or a form of promissory note or security; a receipt, acknowledgement or other form of arrangements or representations of a holder of IP Numbers' commitment of one or more IP Numbers for the benefit of the holder of the instrument. The IP Number may be an IPv4 IP Number. Alternatively, the IP Number may be an IPv6 IP Number. The IP Unit may represent indefeasible right of use of the IP Number. The storage device may further store executable instructions for the processing unit to configure the system to: receive via the network a request from a first party operating the first party device to be a holder of an IP Unit; determine whether the first party is qualified to be the holder of the IP Unit; upon determining the first party is not qualified to be the holder of the IP Unit, send a message over the network requesting the first party to execute a master agreement setting out standard terms that apply to registration and maintenance of the IP Unit and transactions entered into between parties in respect of the IP Unit; and upon receiving over the network a notification of the first party executing the master agreement, automatically assign to the first party the unique central registry ID and register an identity of the first party and the unique central registry ID in a central database of recognized entities authorized to be holder of IP Units.

To determine whether the first party is qualified to be the holder of the IP Unit; the storage device may further store executable instructions for the processing unit to configure the system to: request identification information from the first party; and upon receiving the identification information from the first party, reference the central database of recognized entities to determine whether the identification information is stored therein. To determine whether the second party device is qualified to transact IP Units, the storage device may further store executable instructions for the processing unit to configure the system to: request identification information from the second party device; and upon receiving the identification information from the second party device, reference a central database of recognized entities to determine whether the identification information is stored therein and a level of access assigned to the identification information, the level of access defining whether the second party device is authorized to transact IP Units.

The storage device may further store executable instructions for the processing unit to configure the system to enable electronic interfaces between first and second party devices, the central database, the trading database, and established trading and clearing systems to facilitate inquiry and trading of transactions involving IP Units. The storage device may further store executable instructions for the processing unit to configure the system to enable the first party device access to a register software application for registering IP Units with the central registry computer system. The storage device may further store executable instructions for the processing unit to configure the system to forward the transfer notification to network operators, an Internet Assigned Numbers Authority, and/or a Regional Internet Register to reflect the transfer of IP Units between the account associated with the first party device and the account associated with the second party device. The storage device may further store executable instructions for the processing unit to configure the system to forward the transfer notification to a database of recognized entities to reflect the transfer of IP Units between the account associated with the first party device and the account associated with the second party device.

In another general aspect, the instant application describes a method implemented by a computer including receiving a registration request from a first party device to register an IP Unit representing an IP Number in a central database of IP Units; upon receiving the registration request, identifying a unique central registry ID associated with the first party device; registering in the central database of IP Units the IP Unit against the unique central registry ID associated with the first party device; receiving from a second party device a transaction request for transacting IP Units; determining whether the second party device is qualified to transact IP Units; upon determining the second party device is qualified to transact IP Units, enabling the second party device access to a trading database recording availability of IP Units and open interest of potential sellers or buyers of one or more IP Units; responsive to enabling access to the trading database, receiving a transaction notification of IP Unit transaction between the first party device and the second party device; responsive to the transaction notification, automatically generating a transfer notification to reflect transfer of IP Units between an account associated with the first party device and an account associated with the second party device; and forwarding the transfer notification to a transfer notification database to enable the transfer notification database to update the central database of IP Units to reflect the transfer of IP Units between the account associated with the first party device and the account associated with the second party device.

The above general aspect may include one or more of the following features. The IP Number may be an IPv4 Number. Alternatively, the IP Number may be an IPv6 Number. The IP Unit may represent indefeasible right of use of the IP Number. The method may further include receiving a request from a first party operating the first party device to be a holder of an IP Unit; determining whether the first party is qualified to be the holder of the IP Unit; upon determining the first party is not qualified to be the holder of the IP Unit, sending a message requesting the first party to execute a master agreement setting out standard terms that apply to registration and maintenance of the IP Unit and transactions entered into between parties in respect of the IP Unit; and upon receiving a notification of the first party executing the master agreement, automatically assigning to the first party the unique central registry ID and register an identity of the first party and the unique central registry ID in a central database of recognized entities authorized to be holder of IP Units.

Determining whether the first party is qualified to be the holder of the IP Unit may include: requesting identification information from the first party; and upon receiving the identification information from the first party, referencing the central database of recognized entities to determine whether the identification information is stored therein. Determining whether the second party device is qualified to transact IP Units may include: requesting identification information from the second party device; and upon receiving the identification information from the second party device, referencing a central database of recognized entities to determine whether the identification information is stored therein and a level of access assigned to the identification information, the level of access defining whether the second party device is authorized to transact IP Units.

The method may further include enabling electronic interfaces between first and second party devices, the central database, the trading database, and established trading and clearing systems to facilitate inquiry and trading of transactions involving IP Units. The method may further include enabling the first party device access to a register software application for registering IP Units with a central registry computer system. The method may further include forwarding the transfer notification to network operators, an Internet Assigned Numbers Authority, and/or a Regional Internet Register to reflect the transfer of IP Units between the account associated with the first party device and the account associated with the second party device.

The method may further include forwarding the transfer notification to a database of recognized entities to reflect the transfer of IP Units between the account associated with the first party device and the account associated with the second party device.

In another general aspect, the instant application describes a memory for storing data for access by an application program being executed on a data processing system, comprising: a data structure stored in said memory, said data structure including information resident in a database used by said application program and including: a plurality of attribute data objects stored in said memory, the plurality of attribute data objects including: (1) a unique central registry ID associated with the first party device; (2) an IP Unit associated with the unique central registry ID; and (3) an IP Number associated with the IP Unit.

The above general memory aspect of the instant application may include one or more of the following features. The plurality of attribute data objects may further include an entity status associated with the first party device, form of an agreement executed between the first party device and a central registry, and a date and a version number of executed agreement.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The figures depict one or more implementations in accord with the present teachings, by way of example only, not by way of limitation. In the figures, like reference numerals refer to the same or similar elements.

FIG. 1 illustrates an exemplary system for creating, registering, and trading IP Units representing IP Numbers;

FIG. 2 illustrates exemplary processes for creating IP Units representing IP Numbers and registering IP Units with a central registry system shown in FIG. 1;

FIGS. 3A-3B illustrate in more detail the exemplary process for creating the IP Units;

FIGS. 4A-B and 5 illustrate exemplary tables that may be stored in a database containing various records and fields relating to recognized entities shown in FIG. 1;

FIG. 6 illustrates an exemplary process for registering IP Units in a database of IP Units shown in FIG. 1;

FIG. 7 illustrates an exemplary process used by a central registry shown in FIG. 1 to allow a party to acquire IP Units from a holder of IP Units;

FIG. 8 illustrates a network or host computer platform, as may typically be used to implement a server; and

FIG. 9 illustrates a computer with user interface elements, as may be used to implement a personal computer or other type of work station or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

In one implementation, the instant application describes a computer-based system and methods that enable holders of IP Numbers to create IP Units. An IP Unit is an instrument that represents the right to utilize an IP Number to which the instrument corresponds and may include a share of capital stock or similar interest in an entity or other security convertible or exchangeable into a share of capital stock or similar interest in an entity; a debt obligation or a form of promissory note or security; a receipt, acknowledgement or other form of arrangements or representations of a holder of IP Numbers' commitment of one or more IP Numbers for the benefit of the holder of the instrument.

The computer-based system and method of the instant application enable such IP Units to be recorded in a central database to which interested parties (including network operators and other parties responsible for management or routing of traffic over IP networks) can refer, therefore, creating a mechanism by which parties can reliably reference a central registry of holders in due course of the right to utilize an IP Number as the result of holding an IP Unit. Under certain circumstances, these IP Units may automatically convert into a direct assignment of the corresponding underlying IP Numbers without the holder in due course being required to further prefect its interest assuring the holder of the total benefits of ownership whether held as an IP Unit or as a direct assignee of the IP Number. To this end, the teachings of the instant application can facilitate the creation of exchanges or other forms of markets in which IP Units can be traded or otherwise conveyed to others for consideration leading to a more efficient process for the optimal distribution of IP Numbers to meet the growing demands of organizations and users for IP Numbers in the absence of a legally enforceable and reliable framework for holding, using or transferring such IP Numbers.

In another implementation, the teachings of the instant application can facilitate the creation of enforceable security interests in the IP Units bolstering the efficiency of the process for the transfer of IP Numbers by enabling parties to recognize the value of IP Numbers and secure funding to hold or acquire IP Numbers via IP Units required in the normal course of their operations or otherwise. The teachings of the instant application can also facilitate the rationalization and reallocation of IP Numbers geographically to address the global imbalances that now exist while enticing governments and organizations governing the routing of data packets (and network operators that manage IP Networks) to give effect to the routing in light of the holders in due course of IP Units.

To illustrate, in one specific example, the following approach is used to create an IP Unit which can be conveyed for consideration. An organization that has IP Numbers creates an “Issuer of IP Units” that may be a bankruptcy remote corporate subsidiary, trust, partnership or other entity or contractual arrangement to which the holder of the IP Numbers contributes or commits the IP Numbers as that entity's principal asset together with some amount of cash (e.g., a de minimus amount of cash). The documentation by which the Issuer of IP Units is organized may provide for the creation of two classes of interests that between them represent the totality of the ownership rights of the holders of interests in the entity.

One class of interest provides for a single unit (“Control Unit”) to be issued to the parent entity or party which has organized the Issuer of IP Units, among other terms, provides: (1) 100% of the voting or control rights shall vest in that class and (2) upon liquidation of the Issuer of IP Units, the holder of the Control Unit is entitled to receive cash. In one implementation, the holder of the Control Unit is entitled to receive only cash upon liquidation of the Issuer of the IP Units. The other class of units (i.e., the IP Units) provides for that number of IP Units to be issued equal in number to the total number of IP Numbers that have been contributed or committed to the Issuer of IP Units with each such IP Unit uniquely identified as corresponding to a specifically identified IP Number. The holder of such IP Unit may have, among other possible rights: (1) the indefeasible right to utilize the IP Number which corresponds to the IP Unit; and (2) upon liquidation of the Issuer of the IP Units, the IP Number to which the IP Unit corresponds will be “distributed” (i.e., conveyed) to the holder of such IP Unit.

To further illustrate, in another specific example, the following approach is used by a non-corporate holder of IP Numbers (e.g., a government or a department, agency or instrumentality of a government). Such an organization pledges, places in trust (constructive or otherwise) or otherwise contractually commits itself to be bound to certain of the central registry's rules and procedures with respect to the IP Numbers and causes an Issuer of IP Units to issue receipts, certificates or other evidences of the IP Numbers to be issued as IP Units. These IP Units provide the holder of the IP Unit the indefeasible right to use the IP Number associated with each such IP Unit and, under certain circumstances, to be assigned the IP Number in lieu of holding of the IP Unit.

The Issuer of IP Units and its parent and certain affiliates may enter into a master agreement with a central registry (or an agent of the central registry) that is charged with enforcing a process for the creation of IP Units that are eligible to be recorded by the central registry. The master agreement may set out standard terms that apply to elements of the creation and maintenance of IP Units and transactions entered into between parties in respect of such IP Units. The provisions of the master agreement may be incorporated by reference into each and every transaction that is executed in respect of the IP Units and therefore general terms and conditions as to the IP Units may not need to be re-negotiated or re-documented in each instance. Under the master agreement, the Issuer or IP Units and its sponsor and affiliates may represent and warrant that certain steps have been taken in the creation of the Issuer of IP Units; may irrevocably agree to abide by certain obligations with respect to the maintenance in good standing of the Issuer of IP Units; the sponsor of the Issuer of IP Units may guarantee the obligations of the Issuer of IP Units; and it and the Issuer of IP Unit may agree to abide by the central registry's rules and regulations including submitting to its jurisdiction for resolution of disputes that might arise with a holder in due course of the IP Units. The Issuer of IP Units may then be entitled to cause the central registry to record the creation of the IP Units and to transfer such IP Units to a holder in due course which holder in due course would also have agreed to abide by the central registry's rules and regulations.

The processes that the central registry provides may include: (1) one or more electronic databases that contain information with respect to parties recognized by the central registry as having subscribed to the central registry's master agreement; (2) one or more electronic databases of parties qualified to transact in the IP Units; (3) one or more electronic databases that record the creation and registration of IP Units; (4) one or more electronic databases that record the distribution of IP Numbers to the holders of the corresponding IP Units upon the liquidation or winding up of an Issuer of IP Units; (5) one or more electronic databases that record transfers of IP Units; (6) one or more electronic databases that record and organize information about the availability and prices (bid or ask) for IP Units; (7) one or more electronic databases that record open interest of potential sellers or potential buyers of IP Units; (8) electronic interfaces between and among the databases described above that enable automated inquiry and validation and that provide for the overall administration and security of the central registry's databases; (9) automated settlement and clearing arrangements that parties transacting in the IP Units may use to settle transactions; (10) electronic interfaces between the central registry's databases and established trading and clearing systems (e.g., CUSIP Global Services operated by Standard & Poor's on behalf of the American Bankers Association or International Securities Identification Number as defined in the International Organization for Standardization's ISO 6166) to facilitate inquiry and trading and settlement of transactions involving the IP Units; (11) electronic interfaces between the central registry's database and systems maintained by network operators, ICANN (and IANA) and RIRs to facilitate updating of routing tables as the result of trading and settlement activities involving IP Units; (12) one or more web portals via which parties can query the central registry's databases (including creation of one or more levels of access to information available on such portal based upon the identity of the querying party or the nature of the inquiry); (13) one or more electronic interfaces with information service providers, publishers and other parties that disseminate information; (14) one or more application program interfaces to facilitate integration of the central registry's applications and databases with platforms and applications maintained by others.

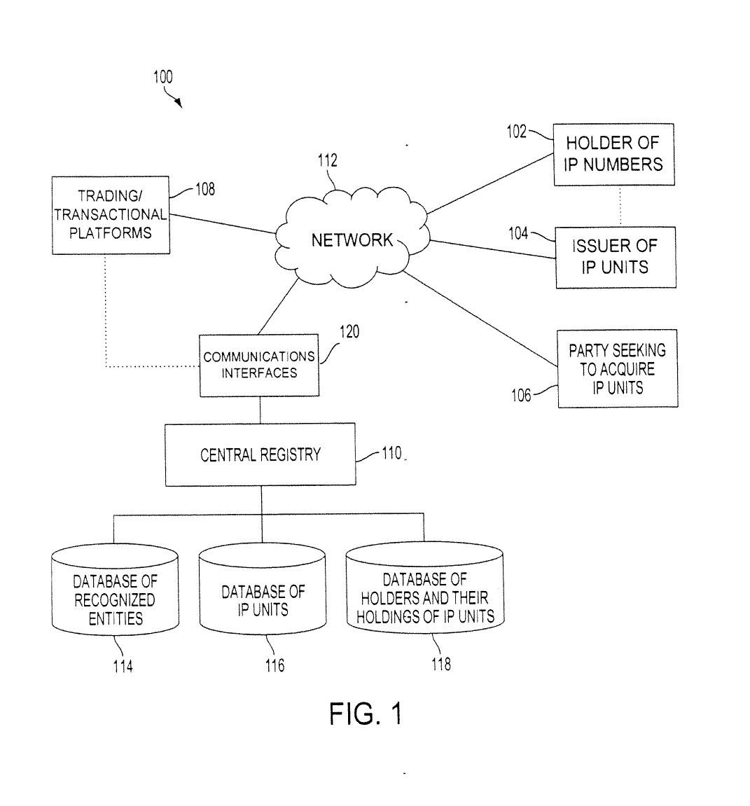

Reference now is made in detail to the examples illustrated in the accompanying drawings and discussed below. FIG. 1 illustrates an exemplary system 100 for creating, registering, and trading IP Units. The system 100 includes a holder of IP Numbers 102, an Issuer of IP Units 104, a party seeking to acquire IP Units 106, a trading/transaction platform 108, and a central registry 110 communicating with each other through a network 112. The system 100 also includes databases 114, 116, and 118 in communication with the central registry 110.

The holder of IP Numbers 102 may be directly responsible for the creation and management of IP Units or may organize an “Issuer of IP Units” that may be a government body, corporation, trust, partnership or other form or type of entity organized pursuant to law that issues or may issue IP Units, and includes a contractual arrangement with such an entity pursuant to which IP Units have been or may be issued by the Issuer of IP Units. The creation and management of IP Units may involve various legal and organizational steps undertaken by the holder of IP Numbers 102 in accordance with the laws of the jurisdiction governing the holder of IP Numbers 102 and the Issuer of IP Units 104; the organic documentation by which the holder of IP Numbers 102 and the Issuer of IP Units 104 operate; and a series of interactions with the central registry 110 to qualify as recognized entities for purposes of the central registry 110 and to record in the central registry 110 the existence, status and ownership of IP Units.

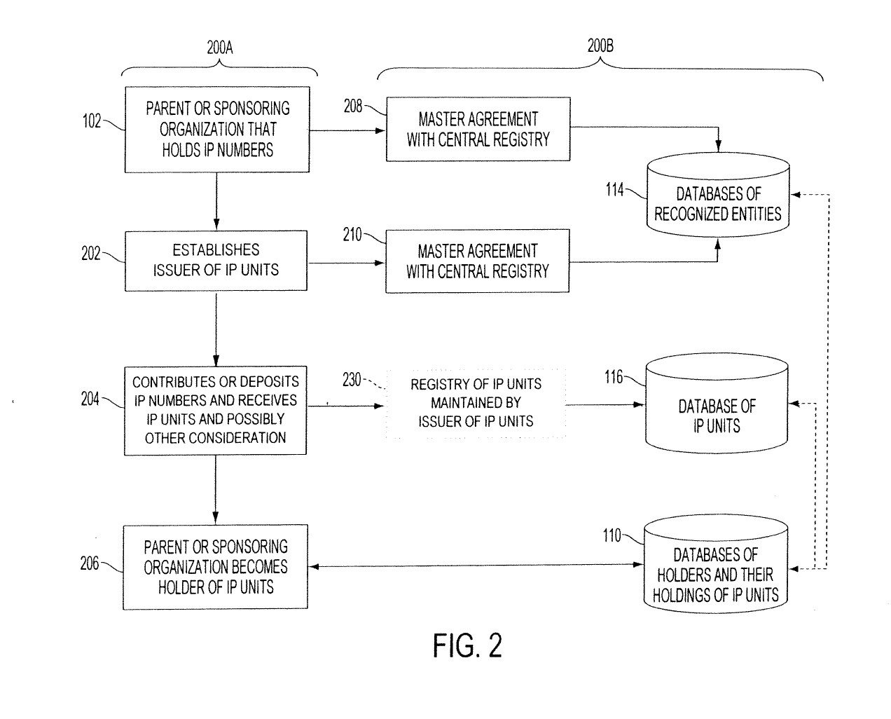

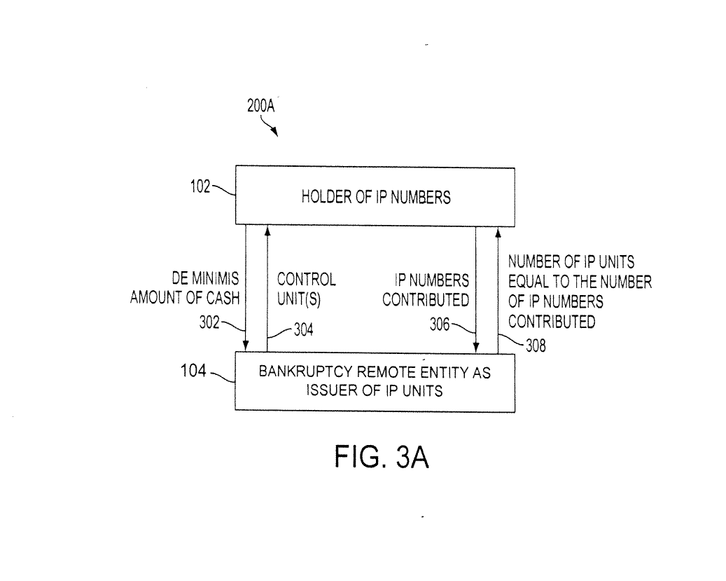

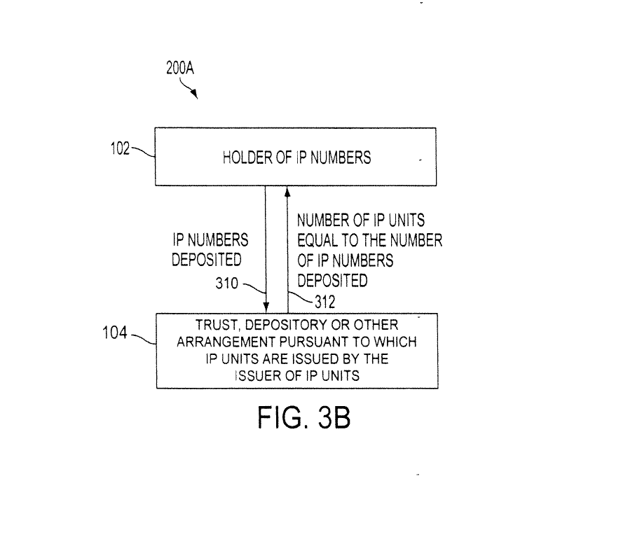

While the precise legal or organizational steps may vary by jurisdiction and legal form of the holder of IP Numbers 102 and the Issuer of IP Units 104, in one implementation, the holder of the IP Numbers 102 may undertake such corporate or organizational steps as are required to create a subsidiary, affiliate or arrangement that is structured to minimize the possibility of a bankruptcy or insolvency of that subsidiary, affiliate or arrangement (e.g., a “Bankruptcy Remote Entity” as an Issuer of IP Units 104). The Bankruptcy Remote Entity may receive some amount of cash and the IP Numbers from the holder of IP Numbers 102. In return, the Bankruptcy Remote Entity may authorize and deliver units (or other forms of evidence of interests as may be appropriate within the jurisdiction in which the entities operate) to the holder of IP Numbers 102. The units may include two classes: (a) a Control Unit (or some number of Control Units as may be required by the laws or regulations of the jurisdiction) representing voting or controlling interests in the Bankruptcy Remote Entity and (b) such number of non-voting interests in the Bankruptcy Remote Entity that equals the number of IP Numbers contributed by the holder of IP Numbers 102 (i.e., the IP Units). The processes for creating Control Units and IP Units are described in more detail with respect to FIGS. 2 and 3.

In general (and specifically in order to qualify the IP Units for inclusion in the central registry's 110 systems upon such terms and conditions as the central registry 110 may from time to time require), the charter or other form of documentation by which the Issuer of IP Units 104 was organized may provide: (a) each IP Unit represents the indefeasible and inalienable right for the holder of the IP Unit to utilize the specific IP Number associated with the IP Unit; (b) upon the termination, liquidation, winding-up, dividend or other action by which assets of the Issuer of IP Units 104 are distributed, the holder of Control Units (e.g., the initial holder of IP Numbers 102) is entitled to receive cash (or equivalent consideration but not including IP Numbers) and the holder of each IP Unit receives the distribution and assignment of the IP Number to which the IP Unit corresponds; (c) the Issuer of IP Units 104 is prohibited from creating additional classes of units or beneficial interests (provided; however, additional IP Units may be issued by the Issuer of IP Units 104 in such precise number as reflects additional IP Numbers contributed by the sponsoring entity or organization); (d) the Issuer of IP Units 104 is prohibited from incurring debt; (e) the Issuer of IP Units 104 is prohibited from filing bankruptcy or seeking any other form of court or administrative protection from creditors; and (f) the Issuer of IP Units 104 is obligated to take steps required or necessary to preserve the validity and recognition of its rights to the IP Numbers that have been contributed to the Issuer of IP Units 104.

In general (and specifically in order to qualify the parent or sponsoring entity 102 and the Issuer of IP Units 104) for registration with the central registry's 110 systems upon such terms and conditions as the central registry may from time to time require, the parent or sponsoring organization 102 that has created the Issuer of IP Units 104 may: (a) have limited rights to transfer Control Units to a party not under common control of the parent or sponsoring organization 102; (b) guarantee the due performance and financial obligations of the Issuer of IP Units 104; (c) be obligated to pay the expenses directly or via contribution of additional cash to the Issuer of IP Units 104 from time to time (for which the parent or sponsoring organization 102 may receive additional Control Units) as may be required by the Issuer of IP Units 104 to fund it normal operations; and (d) be obligated to take steps required or necessary to preserve the validity and recognition of its rights to the IP Numbers that have been contributed to the Issuer of IP Units 104.

A parent or sponsoring organization 102 and the Issuer of IP Units 104 each may manually or electronically execute a master agreement with the central registry 110. The holder of IP Numbers 102 and the Issuer of IP Units 104 may communicate with the central registry 110 over the central registry's private network 112 or via secure communications protocols through the central registry's communications interfaces 120 over the Internet to execute the master agreement. The master agreement may outline the obligations of the holder of IP Numbers 102 and, if applicable, the Issuer of IP Units 104. The central registry 110 connects to the network 110 via a communication interface 120.

The central registry's network platform 112 allows the holder of IP Numbers 102, the Issuer of IP Units 104, and a party seeking to acquire IP Units 106 to communicate with one another and with the central registry 110 and one or more trading/transaction platforms 108. The network or system platform 112 typically offers a variety of data services, such as downloads, synchronization of server and client data, notifications, etc. In keeping with the previous example, the central registry's network 112 allows the holder of IP Numbers 102 and the Issuer of IP Units 104 to download master agreements from the central registry 110 for electronic or manual execution utilizing XML-based web pages or other application programming interfaces (and “API” or “APIs”). The central registry's network 112 can be implemented based upon proprietary and standards based networking technologies, operating systems and applications.

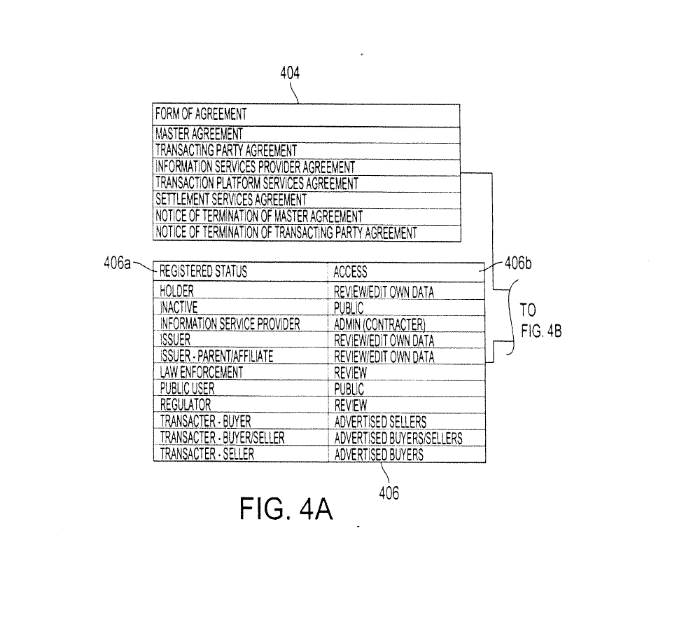

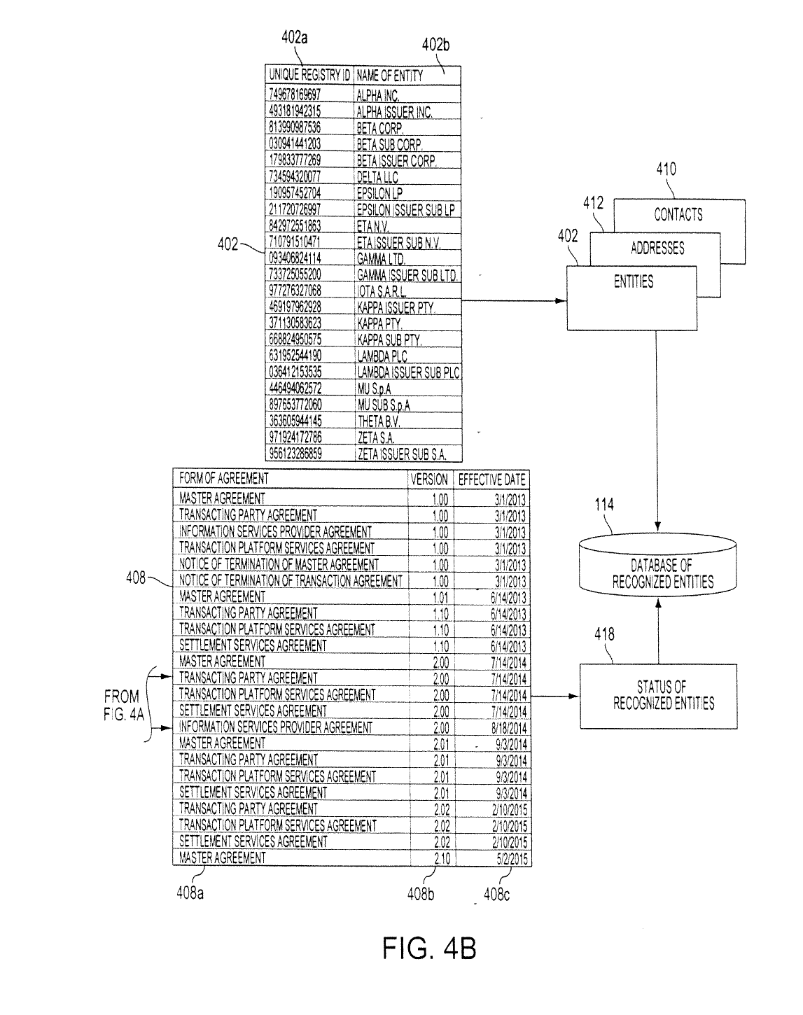

Referring also to FIGS. 4A and 4B, the executed master agreements and such other agreements as may be appropriate to be executed may be recorded in the central registry's database of recognized entities 114. The identities of the sponsoring holder of IP Numbers 102 and Issuer of IP Units 104 which have executed the master agreement (e.g., the recognized entities) may also be recorded in the database of recognized entities 114. Various additional items of information about the recognized entities may also be collected and maintained in the central registry's database of recognized entities 114 including, but not limited to, information about the address or addresses of recognized entities and persons that may be contacted in respect of the recognized entity. The central registry's database of recognized entities 114 may also record information about one or more agreements that a recognized party has executed that govern the nature and extent of the party's access to the various databases and systems associated with the central registry 110.

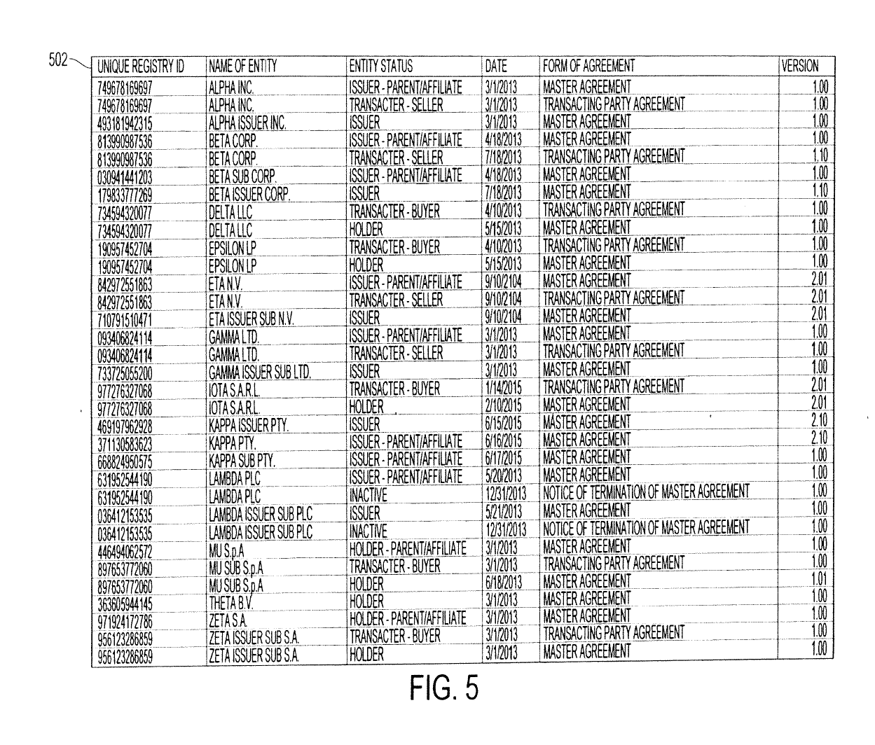

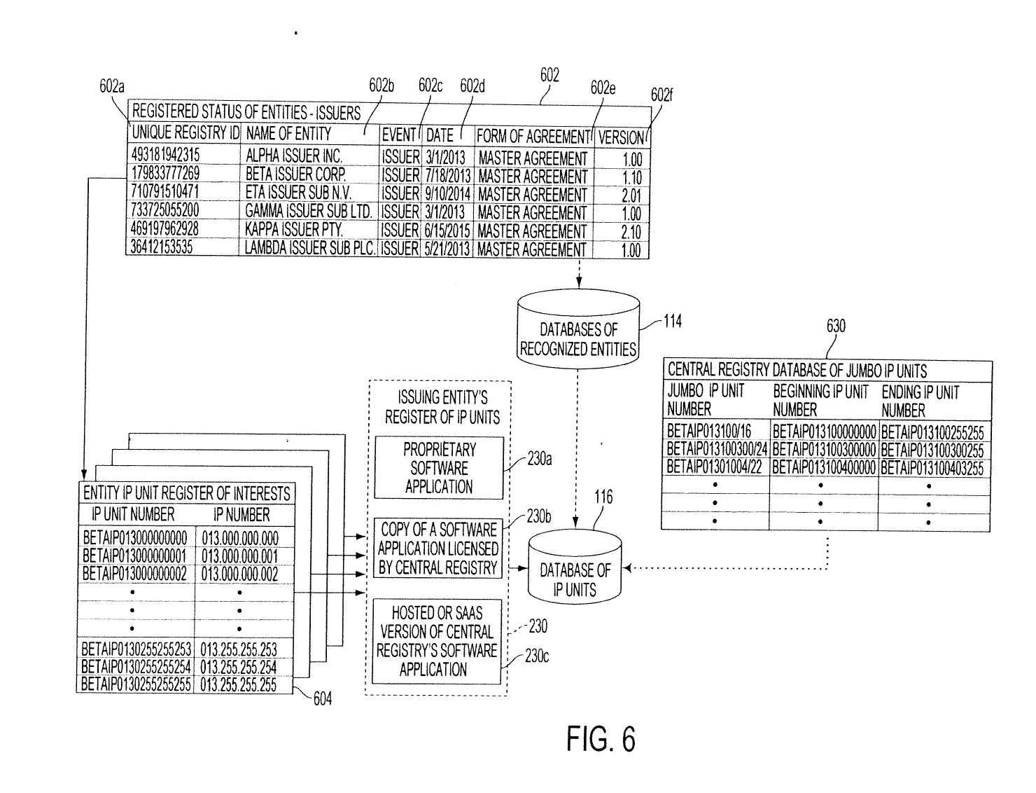

Referring also to FIGS. 2 and 6, the IP Units issued by Issuer of IP Units 104 and recognized by the central registry 110 may be recorded on a register application 230. The register application 230 may be a proprietary software application 230a, a copy of the central registry's 110 software application 230b licensed for use by the Issuer of IP Units 104 or such similar software application hosted or delivered by the central registry 110 as a software-as-a-service 230c. The IP Units registered with the central registry 110 by the Issuer of IP Units 104 may be recorded in the database of IP Units 116. The registered IP Units may be addressed singly or together with other IP Units and represented by “jumbo” IP Units using a nomenclature that generally reflects Classless Inter-Domain Routing (or “CIDR”) notation 630, as shown in FIG. 6. The database of recognized entities 114 and the database of IP Units 116 may be linked and may support a database of holders of IP Units 118.

The database of IP Units 116 in respect of IPv4 Numbers could theoretically include approximately 4.3 billion records (i.e., 2³², the maximum number of IPv4 IP Numbers); however, the total number of IP Units may be substantially less than the maximum potential. Similarly, the maximum number of IP Units that might be issued in respect of IPv6 IP Numbers and reflected in the database of IP Units 116 may be 2¹²⁸ although in practice the number of IP Units issued in respect of IPv6 IP Numbers may be very substantially less than the maximum number of IPv6 IP Numbers.

Referring also to FIGS. 4 and 7, the party seeking to acquire IP Units 106 may register with the central registry 110 and execute the various agreements listed in table 404 appropriate to the role the party intends to pursue if the party is not already appropriately qualified. Once qualified to transact in and if appropriate, to be a holder of IP Units, the party seeking to acquire IP Units 106 may choose to privately pursue a transaction with the holder of IP Units (in one implementation, formerly a holder of IP Numbers 102 which have theretofore been contributed to the Issuer of IP Units 104) on such financial terms and conditions as the parties agree. Parties seeking to transact (as a buyer or a seller) may also utilize a quotation system offered by the central registry 110 (or quotation systems offered by independent parties that have contracted with the central registry 110 to gain access to its database and systems). Alternatively or additionally, the parties may choose to transact via a trading and transactional platform 108. The trading and transaction platform 108 may be maintained by the central registry 110 or offered by independent parties that have contracted with the central registry 110 to gain access to its databases and systems. Settlement of a transaction may be coordinated via a system maintained by the central registry 110. In any case, a transaction between the recognized entities may be settled and transferred via the central registry's 110 systems with a transfer notification generated and automatically incorporated into the central registry's 110 database of transfers, which may trigger an automated notification as appropriate to network operators, ICANN (and IANA), a RIR or other interested parties. An update of the central registry's 110 database of transfers automatically updates the central registry's 110 database of holders of IP Units 116.

FIG. 2 illustrates exemplary processes 200A and 200B for creating IP Units representing IP Numbers and registering IP Units with the central registry 110 shown in FIG. 1. Specifically, process 200A describes steps for creating IP Units and process 200B describes steps for registering the then created IP Units with the central registry 110 shown in FIG. 1. The actors involved in the processes 200A and 200B include the initial holder of the IP Numbers 102, the Issuer of IP Units 104, and databases 114, 116, and 118. The initial holder of the IP Numbers 102, the Issuer of IP Units 104, and databases 114, 116, and 118 are the same as those shown and described with respect to FIG. 1. Therefore, for the sake of simplicity and brevity of description, they are labeled with the same reference numerals and their redundant aspects are not described here in more details.

The process 200A begins with the holder of IP Numbers 102 creating an Issuer of IP Units 104 (Step 202) which may be a government body, corporation, trust, partnership or any other form or type of entity organized pursuant to law that issues or may issue IP Units, and includes any contractual arrangement with any such entity pursuant to which IP Units have been or may be issued. The holder of IP Numbers 102 contributes IP Numbers and to the extent required, cash to the Issuer of IP Units 104 for Control Units and IP Units in return (Step 204). After receiving the Control Units and the IP Units, the former holder of IP Numbers 102 becomes the holder of the IP Units (step 206).

FIG. 3A illustrates in more detail the exemplary process 200A for creating the IP Units, where the Issuer of IP Units 104 correspond to Bankruptcy Remote Entity. The holder of IP Numbers 102 gives some amount of cash to the newly created Bankruptcy Remote Entity as the Issuer of IP Units 104 (Step 302). In return, the Issuer of IP Units 104 assigns Control Units to the holder of IP Numbers 102 (Step 304). The Control Units represent the class of voting or controlling interests in the Bankruptcy Remote Entity as the Issuer of IP Units 104. The holder of IP Numbers 102 also contributes the IP Numbers to the Bankruptcy Remote Entity as Issuer of IP Units 104 (step 306). In return, the Bankruptcy Remote Entity as the Issuer of IP Units 104 issues IP Units to the former holder of IP Numbers 102 (Step 308). The number of IP Units issued may be equal to the number of contributed IP Numbers. The IP Units represent non-voting interests in the Bankruptcy Remote Entity as the Issuer of IP Units 104. Although such interests are referred to here as units, it may in fact refer to an instrument that represents the indefeasible right to utilize an IP Number to which the instrument corresponds and may include a share of capital stock or a security convertible or exchangeable into a share of capital stock; a debt obligation or a form of promissory note or security; a receipt, acknowledgement or another form of arrangement or representation of a holder of IP Numbers' commitment of one or more IP Numbers for the benefit of the holder of the instrument.

FIG. 3B also illustrates in more detail the exemplary process 200A for creating the IP Units. where the Issuer of IP Units 104 correspond to a trustee, custodian or other depository or agency. In this case, the holder of IP Numbers 102 deposits the IP Numbers with the trustee, custodian or other depository or agency which issues IP Units as the Issuer of IP Units 104 (step 310). In return, the Issuer of IP Units 104 issues IP Units to the former holder of IP Numbers 102 (Step 312).

Referring again to FIG. 2, the holder of IP Numbers 102 enters into a master agreement with the central registry 110 (Step 208). The Step 208 may happen before, after, or during the establishment of the Issuer of IP Units 104 in Step 202. The master agreement along with the identity of the holder of IP Numbers 102 which has executed the master agreement (e.g., the recognized entity) is recorded in the central registry's database of recognized entities 114. Referring also to FIGS. 4A-B and 5, various additional items of information about recognized entities may also be collected and maintained in the central registry's database of recognized entities 114 including, but not limited to, information about the address or addresses of recognized entities and persons that may be contacted in respect of the recognized entity. The central registry's database of recognized entities 114 may also record information about the one or more or agreements, protocols or other set of rules or procedures that a recognized party has executed that govern the nature and extent of the party's access to the various databases and systems associated with the central registry 110.

FIGS. 4A-B and 5 illustrate exemplary tables of content that may be stored in the central registry's database of the recognized entities 114. Specifically, FIGS. 4A-B illustrate a recognized entities table 402, a forms of agreement table 404, a registered status table 406, a more detailed forms of agreement table 408, a contacts table 410, and an addresses table 412. The recognized entities table 402 identifies the names and associative identification of the entities that have entered into a master agreement with the central registry 110. To this end, the recognized entities table may include among other items of information a unique registry ID column 402a and a name of entity column-402b. The unique registry ID column 402a includes unique identifications associated with each of the entities listed in the name of entity column 402b. The unique identification is used to identify various data associated with the registered entity associated therewith. In one example, such data includes entity's registered status, date of registration, and existence of executed agreements by the entity and their corresponding versions.

The forms of agreements table 404 identifies various forms of agreements that may be executed by an entity (e.g., the holder of the IP Numbers 102 and/or the Issuer of IP Units 104). The various forms of agreements may include a master agreement, a transaction party agreement, information service provider agreement, transaction platform service agreement, settlement service agreement, notice of termination of master agreement, and notice of termination of transacting party agreement.

The registered status table 406 identifies the registration status of the registered entities along with their level of access to the central registry's databases. To this end, the registered status table 406 includes among other items of information a registration status column 406a and a level of access column 406b. The registration status column 406a identifies the status of the registered entity which may include such statuses as holder, inactive, information service provider, issuer, issuer-parent/affiliate, law enforcement, public user, regulator, transacter-buyer, transacter-buyer/seller, and transacter-seller. The level of access column 406b identifies various level of access based on the status of the registered entity. For example, the holder of IP Numbers may have review and edit access to its own data, whereas, the transacter-buyer may have access to the central registry's database of registered sellers.

The more detailed forms of agreement table 408 identifies additional information about the various forms listed in table 404. The table 408 includes among other possible items of information a form of agreement column 408a, a version column 408b, and an effective date column 408c. The form of agreement column 408a identifies various forms of agreement. To this end, the content of column 408a is similar to that of table 404. The version column 408b and the effective date column 408c respectively identify the various versions associated with each form of agreement and their effective dates. To illustrate, the table 408 identifies that on Mar. 1, 2013 the first version of the master agreement will have become available, and on Jun. 14, 2013 the second version of the master agreement will have become available. Similarly, the table 408 identifies that on Mar. 1, 2013 the first version of the transacting party agreement will have become available and on Jun. 14, 2013 the second version of the transacting party agreement will have become available.

The database of recognized entities 114 also includes addresses 412 and contacts 410 associated with the recognized entities. Although not specifically shown, the address information of a recognized entity may be associated with the unique identification of the recognized entity. Similarly, the contact information of the recognized entity may be associated with the unique identification of the recognized entity.

In one implementation, the central registry 110 cross reference various tables stored in its database of recognized entities 114 to create a more comprehensive table as shown in FIG. 5. The table 502 includes collection of information from tables shown in FIGS. 4A-B. Specifically, the table 502 includes information from table 402, table 404, table 406, and table 408. To illustrate one specific example, table 502 identifies that the holder of IP Numbers Alpha Inc. is assigned a unique registry ID 749678169697 (ID '697). The ID '697 reflects that Alpha Inc. has an “Issuer—Parent/Affiliate” status (e.g., holder of IP Numbers) by virtue of executing version 1 of the master agreement on Mar. 1, 2013. The ID 31 697 also reflects that Alpha Inc. has a “Transactor—Seller” status by virtue of executing version 1 of the transacting party agreement. The table 502 also shows that the Alpha Inc. has created an Alpha Issuer Inc. subsidiary (e.g., a Bankruptcy Remote Entity as an Issuer of IP Units 104), which has executed a master agreement with the central registry 110 (Steps 202 and 204 shown in FIG. 2). The Alpha Issuer Inc. is assigned a unique registry ID 493181942315 (ID '315). The ID '315 identifiers the status of the Alpha Issuer Inc. as the “Issuer” by virtue of having entered into a master agreement with the central registry 110 on Mar. 1, 2013.

Referring again to FIG. 2, the process 200B also includes registering the IP Units issued by the Issuer of IP Units 104 on a register maintained by the Issuer of IP Unit 104 using a software application 230. Referring also to FIG. 6, this register software application 230 may be a proprietary software application 230a created or acquired by the Issuer of IP Units 104, a copy of a software application 230b supplied by the central registry 110 and licensed to the Issuer of IP Units 104 or a software application hosted or delivered by the central registry 110 as software-as-a-service 230c.

In one implementation, the central registry 110 may push register software application 230 to the Issuer of IP Units 104 through the central registry's network 112. For example, the central registry 110 creates a table 602 of registered entities having “Issuer” status and provides the identified “Issuer” entities in the table 602 with a copy of the registration software 230. Specifically, upon identifying the various issuers by referencing updates to other tables 502 of the central registry's databases 110, the central registry 110 utilizes their IDs to obtain contact information associated with their various entities. Upon identifying the contact information associated with the identified “Issuer,” the central registry 110 may provide the various entities with the software application to allow them to register their respective IP Units with the database 116 of the central registry 110. The table 602 includes a unique registry ID column 602a, a name of entity column 602b, an event column 602c, a date column 602d, a form of agreement column 602e, and a version column 602f. The unique registry ID column 602a identifies the IDs of the entities who have issuer status in the database 114. The name of entity column 602b identifies the name of various entities that have the “Issuer” status in the database 114. The event column 602c is a status column, identifying the status of the entities as “Issuer”. The date column 602d identifies the date on which the entity gained the “Issuer” status (e.g., the date the entity signed the master agreement with the central registry 110). The form of agreement column 602e identifies the forms of agreement executed by the issuer entity (e.g., the master agreement) and the version column 602f identifies the version associated with the executed form of agreement.

In another implementation, the Issuer of IP Units 104 pulls the register application software 230 from the central registry 110. For example, the Issue of IP Units 104 may access the central registry's 110 website manually or electronically via an API-level interface. The website associated with the central registry 110 may request that the Issuer of IP Units 104 log into the central registry 110 to validate the user (real or virtual). To this end, the website may ask the Issuer of IP Units 104 to provide login information. The login information may include a username and a password and such other identification information as is required to satisfy the central registry's 110 electronic security regime. Alternatively or additionally, the login information may include the unique ID assigned to the Issuer of IP Units 104. In response, the Issuer of IP Units 104 provides the login information to the website. Upon successful authentication, the central registry 110 identifies the status associated with the requesting Issuer of IP Units 104. In keeping with the previous example, the central registry 110 uses the ID associated with the Issuer of IP Units 104 and identifies that the requesting party as an Issuer of IP Units 104. Therefore, the central registry 110 accords the level of access appropriate to an “Issuer” to the requesting Issuer of IP Units 104. For example, the central registry 110 may enable the Issuer of IP Units 104 to manually or electronically edit, review and update data about itself. Additionally, the central registry 110 may provide the Issuer of IP Units 104 access to the software application 230 to enable the Issuer of IP Units 104 to register or update data as to IP Units it has issued and the corresponding IP Numbers that it has assigned to IP Units.

In another implementation, the central registry 110 provides a version of the register software 230 delivered either as a hosted application or as software-as-a-service to ICANN (and IANA 722) or one or more of its RIRs 724 to enable these organizations to offer a service of recognizing IP Numbers that have been assigned as IP Units. Specifically, using the central registry's 110 register software 230, a RIR could offer holders of IP Numbers 102 a service by which the holder of IP Numbers 102 could instruct the RIR 724 to register its IP Numbers. A holder of IP Numbers 102 could then avail itself of the other services of the central registry 110 including the creation of IP Units.

The register application 230 allows the Issuer of IP Units 104 to register with the database 116 the IP Units it has issued and their corresponding IP Numbers. In one specific illustrative example, as shown, Bankruptcy Remote Entities recognized by the central registry 110 as Issuer of IP Units 104 include Beta Issuer Corp. The Beta Issuer registers with the database 116 that it has issued IP Units BETAIP013000000000-BETAIP0130255255255 against the assigned IP Numbers 013.000.000.000-013.255.255.255 respectively as shown in table 604. The registered IP Units may be addressed singly or with other IP Units and represented by “jumbo” IP Units using a nomenclature that generally reflects CIDR notation as shown in a table 630. The database of recognized entities 114 and the database of IP Units 116 may be linked and may underpin a database of holders of IP Units 118.

FIG. 7 illustrates an exemplary process 700 used by the central registry 110 to allow the party 106 to acquire IP Units from the holder of IP Units 102 issued by an Issuer of IP Units 104 to which it had contributed it IP Numbers. The process 700 may begin with the party 106 accessing the central registry 110 (Step 702). The party 106 may access the central registry 110 through the network 112. In one specific example, the party 106 utilizes the Internet to access the website hosted by the central registry 110.

Upon accessing the central registry 110, the central registry 110 determines whether the party 106 is a qualified party (Step 704). The qualified party may be a party who has previously executed a master agreement along with a transacting party agreement with the central registry 110 (qualifying the party to be a holder of IP Units in the central registry 110). To make such determination, the central registry 110 May request the party 106 to manually or electronically log into the central registry 110. To this end, the website may include a login page seeking the party's 106 login credential or automated authentication procedures in the case of electronic logons. The login credential may include a username and a password. Alternatively or additionally, the login credential may include the unique registry ID. The login credential may be assigned to the party 106 at the time of execution of the master agreement with the central registry 110.

The party 106 provides the requested login credentials (manually or electronically as the case may be) to the central registry 110. The central registry 110 references a credentials database to determine whether the credentials provided are valid. If so (Step 704, “Yes”), the central registry 110 enables the party 106 to access additional of the central registry's 110 capacities in its effort to acquire IP Units. Once qualified to transact in and, if appropriate, to be a holder of IP Units, the central registry 110 may enable the party 106 access to exemplary processes 706 so that the party 106 can pursue a transaction with the holder of IP Units 102. The exemplary process 706 provides an avenue for the party 106 to privately pursue a transaction with a holder of IP Units 102 on such terms and conditions as the parties 102, 106 agree. Alternatively or additionally, the parties 102, 106 may transact (e.g., as a buyer and a seller) with a quotation system 708 to receive pricing information associated with the IP Units. The quotation system 708 may be maintained by the central registry 110 or by independent parties that have contracted with the central registry 110.

Moving forward, the parties 102, 106 may choose to transact via a trading and transactional platform 710. The trading and transaction platform 710 may be maintained by the central registry 110 or may be maintained by independent parties that have contracted with the central registry 110 to gain access to the central registry's 100 databases and systems. In either case, the trading and transaction platform 710 may be used to enable the parties 102, 106 to sell and/or buy IP Units.

Once a transaction has been agreed and settlement consummated between parties 102, 106, the central registry 110 records settlement information (Step 712). The central registry 110 also make such entries in its databases to reflect the transfer of ownership of IP Units from the selling party 102 to the acquiring party 106 (Step 714). To this end, the central registry 110 may generate transfer notifications to parties designated by either the seller or the buyer or established by contract with the central registry 110 and incorporate the transfer notification into the central registry's database of transfer 716. The database of transfers 716 may trigger an automatic notification 718 as appropriate to network operators 720, IRNA 722, one or more RIRs 724, and/or other interested parties 726. An update of the central registry's database of transfers 716 may also automatically update the central registry database of holders IP Units 118, the database of IP Units 116, and the database of recognized entities 114 to reflect the transfer of IP Units from the selling party 102 to the acquiring party 106.

If the party 702 is not recognized by the central registry 110 as a qualified party (Step 704, “No”), the party 702 is requested to execute a master agreement with the central registry 110 (Step 728). The central registry 110 system may determine that the party 702 is not qualified based upon direct responses by the party 702 to system prompting or may glean it when more the party 702 makes more than a threshold number of attempts to submit credentials which are not recognized by the central registry 110. In one specific example, the central registry 110 provides a “first time user” or a “sign up” process. The process may begin via activation of a specific link on one or more of the pages of the central registry's 110 web site or by activation of links on external web sites linked to the central registry's 110 web site. Triggering the activation processes by clicking on a link on the central registry's 110 web site or via external linkages informs the central registry 110 that the party is either accessing the central registry's 110 system for the first time or seeking to register with the central registry 110 in some new or different capacity. In response, the central registry 110 provides the required information to the requesting party 702 and requests that the party 702 executes a master agreement with the central registry 110 (Step 728) thereupon qualifying the party 106. Upon execution of the master agreement, the central registry 110 may provide the party 106 with other form of agreements as needed or appropriate based upon information provided by the requesting party 106. For example, if the party 106 is qualified to be a buyer, the central registry 110 provides the party 106 with a transacting party agreement or supplement to the master agreement to allow the requesting party 106 to become a buyer of IP Units from a qualified seller (e.g., the party 102). After the execution of the relevant agreements, the central registry 110 updates the database of recognized entities 114 to reflect the status of the party 106 as the qualified buyer. For example, the central registry 110 may update the database to include the party's name, party's unique registry ID, various agreements executed by the party and their respective versions etc.

As noted above, the central registry 110 may provide any of a variety of common application or service functions in support of creating, registering, and trading IP Units. For a given service, including the creation, registration, and trading of IP Units service, an application program within the party 102, 104, 106 may be considered as a ‘client’ and the programming at central registry 110 may be considered as the ‘server’ application for the particular service.

To insure that the application service offered by central registry 110 is available to only authorized parties, the central registry includes an authentication mechanism enforced by an authentication server. The authentication server could be a separate physical server or the authentication server could be implemented as another program module running on the same hardware platform as the server application 110. Essentially, when the server application 110 (central registry 110 in our example) receives a service request from a client application on machines associated with the parties 102, 104, 106, the server application 110 provides appropriate information to the authentication server to allow server application to authenticate the party 102, 104, 106 as outlined above. Upon successful authentication, the authentication server informs the server application 110, which in turn provides access to the service via data communication through the network 112.

As shown by the above discussion, functions relating to the central registry 110 or the parties 102, 104, and 106 may be implemented on computers connected for data communication via the components of the network 112 as shown in FIG. 1. Although special purpose devices may be used, such devices also may be implemented using one or more hardware platforms intended to represent a general class of data processing device commonly used to run “server” programming so as to implement the creation, central registration and exchange of IP Units functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for the creation, central registration and exchange of IP Units. The software code is executable by the general-purpose computer that functions as the central registry server 110 and/or that functions as a party terminal device (e.g., party 102, 104, and/or 106). In operation, the code is stored within the general-purpose computer platform. At other times, however, the software may be stored at other locations and/or transported for loading into the appropriate general-purpose computer system. Execution of such code by a processor of the computer platform enables the platform to implement the methodology for the creation, central registration and exchange of IP Units in essentially the manner performed in the implementations discussed and illustrated herein.

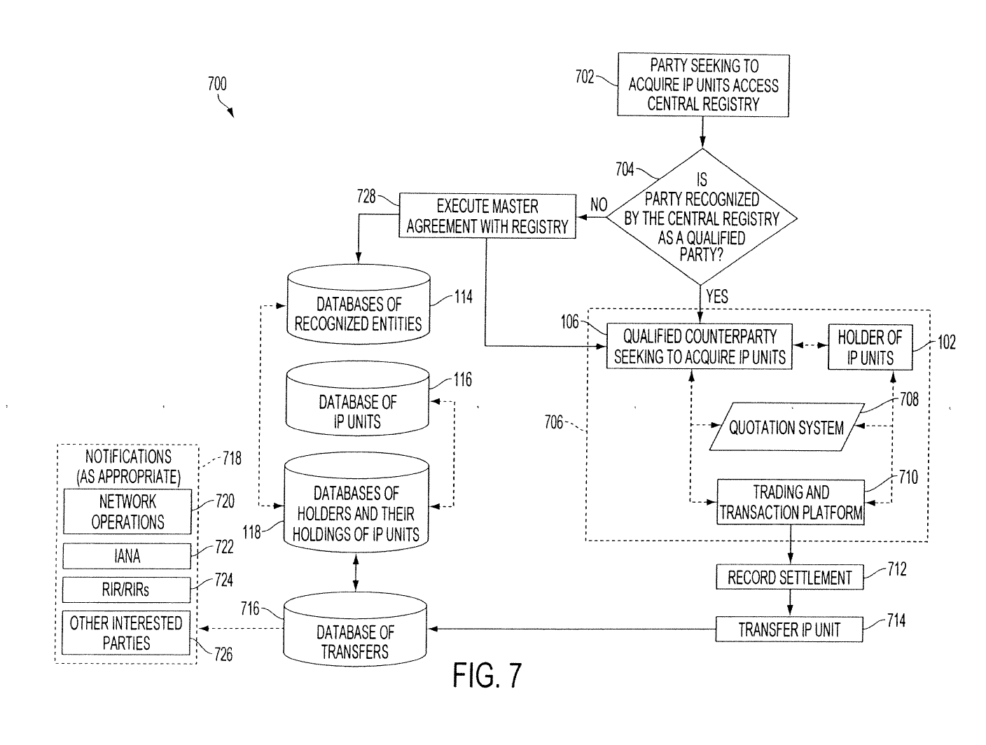

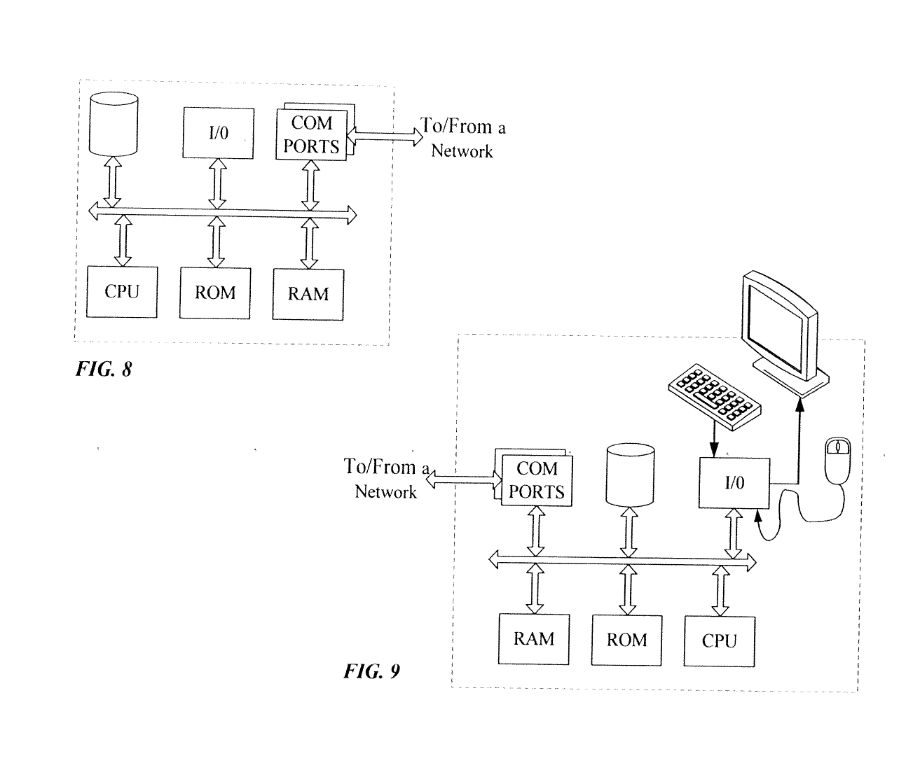

FIGS. 8 and 9 provide functional block diagram illustrations of general purpose computer hardware platforms. FIG. 8 illustrates a network or host computer platform, as may typically be used to implement a server. FIG. 9 depicts a computer with user interface elements, as may be used to implement a personal computer or other type of work station or terminal device, although the computer of FIG. 9 may also act as a server if appropriately programmed. It is believed that those skilled in the art are familiar with the structure, programming and general operation of such computer equipment and as a result the drawings should be self-explanatory.

A server, for example (FIG. 8), includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 9). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature, and it is presumed that those skilled in the art are adequately familiar therewith.

Hence, aspects of the methods of creating, central registering and exchanging of IP Units outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the central registry 110 into the computer platform associated with the parties 102, 104, and/or 106. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the creation, central registration and exchange of IP Units representing IP Numbers. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A central registry electronic system comprising:
a) a network interface configured for communication via a network;
b) a processing unit configured to receive transactions over the network via the interface, each transaction containing a request to (1) register an Internet Protocol (IP) Unit representing an IP Number or (2) transact in an IP Unit;
c) a storage device accessible by the processing unit; and
d) executable instructions stored in the storage device for the processing unit, the instructions configuring the system to:
receive over the network a registration request from a first party device to register the IP Unit in a central database of IP Units;
upon receiving the registration request, identify a unique central registry ID associated with the first party device;
register in the central database of IP Units the IP Unit against the unique central registry ID associated with the first party device;
receive over the network and from a second party device a transaction request for transacting IP Units;
determine whether the second party device is qualified to transact IP Units;
upon determining the second party device is qualified to transact IP Units, enable the second party device access to a trading database recording availability of IP Units and open interest of potential sellers or buyers of one or more IP Units;
responsive to enable access to the trading database, receive over the network a transaction notification of IP Unit transaction between the first party device the second party device;
responsive to the transaction notification, automatically generate a transfer notification to reflect transfer of IP Units between an account associated with the first party device and an account associated with the second party device; and
forward the transfer notification to a transfer notification database to enable the transfer notification database to update the central database of IP Units to reflect the transfer of IP Units between the account associated with the first party device and the account associated with the second party device.

2. The central registry computer system of claim 1, wherein the IP Number is an IPv4 IP Number.

3. The central registry computer system of claim 1, wherein the IP Number is an IPv6 IP Number.

4. The central registry computer system of claim 1, wherein the IP Unit represents indefeasible right of use of the IP Number.

5. The central registry computer system of claim 1, wherein the storage device further stores executable instructions for the processing unit to configure the system to:
receive via the network a request from a first party operating the first party device to be a holder of an IP Unit;
determine whether the first party is qualified to be the holder of the IP Unit;
upon determining the first party is not qualified to be the holder of the IP Unit, send a message over the network requesting the first party to execute a master agreement setting out standard terms that apply to registration and maintenance of the IP Unit and transactions entered into between parties in respect of the IP Unit; and
upon receiving over the network a notification of the first party executing the master agreement, automatically assign to the first party the unique central registry ID and register an identity of the first party and the unique central registry ID in a central database of recognized entities authorized to be holder of IP Units.

6. The central registry computer system of claim 5, wherein to determine whether the first party is qualified to be the holder of the IP Unit; the storage device further stores executable instructions for the processing unit to configure the system to:
request identification information from the first party; and
upon receiving the identification information from the first party, reference the central database of recognized entities to determine whether the identification information is stored therein.

7. The central registry computer system of claim 1, wherein to determine whether the second party device is qualified to transact IP Units, the storage device further stores executable instructions for the processing unit to configure the system to:
request identification information from the second party device; and
upon receiving the identification information from the second party device, reference a central database of recognized entities to determine whether the identification information is stored therein and a level of access assigned to the identification information, the level of access defining whether the second party device is authorized to transact IP Units.

8. The central registry computer system of claim 1, wherein the storage device further stores executable instructions for the processing unit to configure the system to enable electronic interfaces between first and second party devices, the central database, the trading database, and established trading and clearing systems to facilitate inquiry and trading of transactions involving IP Units.

9. The central registry computer system of claim 1, wherein the storage device further stores executable instructions for the processing unit to configure the system to enable the first party device access to a register software application for registering IP Units with the central registry computer system.

10. The central registry computer system of claim 1, wherein the storage device further stores executable instructions for the processing unit to configure the system to forward the transfer notification to network operators, an Internet Assigned Numbers Authority, and/or a Regional Internet Register to reflect the transfer of IP Units between the account associated with the first party device and the account associated with the second party device.

11. The central registry computer system of claim 1, wherein the storage device further stores executable instructions for the processing unit to configure the system to forward the transfer notification to a database of recognized entities to reflect the transfer of IP Units between the account associated with the first party device and the account associated with the second party device.

12. A method implemented by a computer, the method comprising:
receiving a registration request from a first party device to register an IP Unit representing an IP Number in a central database of IP Units;
upon receiving the registration request, identifying a unique central registry ID associated with the first party device;
registering in the central database of IP Units the IP Unit against the unique central registry ID associated with the first party device;
receiving from a second party device a transaction request for transacting IP Units;
determining whether the second party device is qualified to transact IP Units;
upon determining the second party device is qualified to transact IP Units, enabling the second party device access to a trading database recording availability of IP Units and open interest of potential sellers or buyers of one or more IP Units;
responsive to enabling access to the trading database, receiving a transaction notification of IP Unit transaction between the first party device and the second party device;
responsive to the transaction notification; automatically generating a transfer notification to reflect transfer of IP Units between an account associated with the first party device and an account associated with the second party device; and
forwarding the transfer notification to a transfer notification database to enable the transfer notification database to update the central database of IP Units to reflect the transfer of IP Units between the account associated with the first party device and the account associated with the second party device.

13. The method of claim 12, wherein the IP Number is a IPv4 Number.

14. The method of claim 12, wherein the IP Number is a IPv6 Number.

15. The method of claim 12, wherein the IP Unit represents indefeasible right of use of the IP Number.

16. The method of claim 12, further comprising:
receiving a request from a first party operating the first party device to be a holder of an IP Unit;
determining whether the first party is qualified to be the holder of the IP Unit;
upon determining the first party is not qualified to be the holder of the IP Unit, sending a message requesting the first party to execute a master agreement setting out standard terms that apply to registration and maintenance of the IP Unit and transactions entered into between parties in respect of the IP Unit; and
upon receiving a notification of the first party executing the master agreement, automatically assigning to the first party the unique central registry ID and register an identity of the first party and the unique central registry ID in a central database of recognized entities authorized to be holder of IP Units.

17. The method of claim 16, wherein determining whether the first party is qualified to be the holder of the IP Unit includes:
requesting identification information from the first party; and
upon receiving the identification information from the first party, referencing the central database of recognized entities to determine whether the identification information is stored therein.

18. The method of claim 12, wherein determining whether the second party device is qualified to transact IP Units includes:
requesting identification information from the second party device; and
upon receiving the identification information from the second party device, referencing a central database of recognized entities to determine whether the identification information is stored therein and a level of access assigned to the identification information, the level of access defining whether the second party device is authorized to transact IP Units.

19. The method of claim 12, further comprising enabling electronic interfaces between first and second party devices, the central database, the trading database, and established trading and clearing systems to facilitate inquiry and trading of transactions involving IP Units.

20. The method of claim 12, further comprising enabling the first party device access to a register software application for registering IP Units with a central registry computer system.

21. The method of claim 12, further comprising forwarding the transfer notification to network operators, an Internet Assigned Numbers Authority, and/or a Regional Internet Register to reflect the transfer of IP Units between the account associated with the first party device and the account associated with the second party device.

22. The method of claim 12, further comprising forwarding the transfer notification to a database of recognized entities to reflect the transfer of IP Units between the account associated with the first party device and the account associated with the second party device.

23. A memory for storing data for access by an application program being executed on a data processing system, comprising: a data structure stored in said memory, said data structure including information resident in a database used by said application program and including: a plurality of attribute data objects stored in said memory, the plurality of attribute data objects including: (1) a unique central registry ID associated with the first party device; (2) an IP Unit associated with the unique central registry ID; and (3) an IP Number associated with the IP Unit.

24. The memory of claim 23, wherein the plurality of attribute data objects further includes an entity status associated with the first party device, form of an agreement executed between the first party device and a central registry, and a date and a version number of executed agreement.
